(19) United States
(12) Patent Application Publication
(10) Pub. No.: US 2026/0274746 A1
(43) Pub. Date: Sep. 17, 2026

(54) STRENGTHENED CALCIUM CARBONATE CEMENTITIOUS COMPOSITION

(71) Applicant: Arelac, Inc., San Jose, CA (US)

(72) Inventors: Sarah Granke Plata, San Jose, CA (US); Zachary N. Haber, San Jose, CA (US); Seung-Hee Kang, Campbell, CA (US)

(21) Appl. No.: 19/559,708

(22) Filed: Mar. 6, 2026

Related U.S. Application Data
(60) Provisional application No. 63/772,274, filed on Mar. 14, 2025.

(51) Int. Cl. C04B 7/34; C04B 7/42; C04B 7/43

(52) U.S. Cl. CPC C04B 7/34; C04B 7/425; C04B 7/434; C04B 2201/50

(57) ABSTRACT

Various examples relate to cementitious compositions as well as system and method to produce a cementitious composition which includes vaterite with incorporated sulfate for superior properties such as compressive strength. The sulfate may be provided as gypsum in various examples. The sulfate may be incorporated and infused during the synthesis of vaterite, or may be blended with the vaterite later directly dry or in aqueous form. Specific ratios of the weights of different constituents such as vaterite, sulfate, and other additive may be used for appropriate applications.

### CROSS-REFERENCE TO RELATED APPLICATION

This application claims the benefit of priority to U.S. Provisional Patent Application Ser. No. 63/772,274 entitled “Strengthened Calcium Carbonate Cementitious Composition”, filed Mar. 14, 2025, the disclosure of which is incorporated herein in its entirety by reference.

### BACKGROUND

As the largest manufactured product in the world, cement production plays a substantial role in anthropogenic CO₂ emissions, contributing to approximately 7-8% of these emissions, as well as consuming over 3% of the global energy demand and emitting over 5% of global anthropogenic emissions of particles smaller than 10 micrometers.

Given the ongoing global trends of population growth and urbanization, these environmental impacts are expected to persist unless mitigation strategies are implemented. In recent years, various technical measures have emerged to mitigate these impacts. For instance, the waste CO₂ from cement kilns and fossil fuel incinerators may be harnessed through processes such as carbonation curing, secondary chemical reactions for carbon capture, or geological storage. However, these measures frequently encounter technical and economic challenges when applied in cement plants, especially in developing countries where most cement products may be produced and used.

It is therefore desirable to find alternative ways to produce low or zero carbon emission cement.

### SUMMARY

In some examples, the techniques described herein relate to a cementitious composition including at least 50% vaterite and 0.1 to 5% sulfate by weight.

In some examples, the techniques described herein relate to a cementitious composition, further including by weight of up to 50% calcium carbonate seed.

In some examples, the techniques described herein relate to a cementitious composition, wherein the cementitious composition further includes calcite seed.

In some examples, the techniques described herein relate to a cementitious composition, wherein calcium carbonate seed is up to 100% calcite seed.

In some examples, the techniques described herein relate to a cementitious composition, wherein calcium carbonate seed includes aragonite seed.

In some examples, the techniques described herein relate to a cementitious composition, wherein the sulfate is provided as calcium sulfate.

In some examples, the techniques described herein relate to a cementitious composition, wherein the sulfate is provided as gypsum.

In some examples, the techniques described herein relate to a cementitious composition, further including sodium sulfate.

In some examples, the techniques described herein relate to a cementitious composition, wherein the sulfate is infused in the vaterite.

In some examples, the techniques described herein relate to a cementitious composition, wherein impurities are filtered out of the cementitious composition.

In some examples, the techniques described herein relate to a method for forming a cementitious composition, the method including: calcining limestone in kiln to form lime and a gaseous stream including carbon dioxide; dissolving the lime in an aqueous solution including a nitrogen containing salt to produce an aqueous solution including calcium salt; and, treating the aqueous solution including calcium salt with sulfate and the gaseous stream including carbon dioxide to form a precipitation material and thereby forming the cementitious composition.

In some examples, the techniques described herein relate to a method, wherein the cementitious composition includes vaterite.

In some examples, the techniques described herein relate to a method, further filtering out impurities prior to treating the aqueous solution.

In some examples, the techniques described herein relate to a method, further adding calcium carbonate seeds to the cementitious composition.

In some examples, the techniques described herein relate to a method, wherein calcium carbonate seed is up to 100% calcite seed.

In some examples, the techniques described herein relate to a method, wherein calcium carbonate seed includes aragonite seed.

In some examples, the techniques described herein relate to a method, wherein the sulfate is provided as calcium sulfate.

In some examples, the techniques described herein relate to a method, wherein the sulfate is provided as gypsum.

In some examples, the techniques described herein relate to a method, further including sodium sulphate.

In some examples, the techniques described herein relate to a method, wherein the sulfate is infused in the vaterite.

In some examples, the techniques described herein relate to a method for forming a cementitious composition, the method including adding sulfate to vaterite, wherein the sulfate is 0.1 to 8% by weight of the vaterite.

In some examples, the techniques described herein relate to a method, further adding calcium carbonate seeds to the cementitious composition.

In some examples, the techniques described herein relate to a method, wherein calcium carbonate seed is up to 100% calcite seed.

In some examples, the techniques described herein relate to a method, wherein the calcium carbonate seed includes aragonite seed.

In some examples, the techniques described herein relate to a method, wherein the sulfate is provided as calcium sulfate.

In some examples, the techniques described herein relate to a method, wherein the sulfate is provided as gypsum.

In some examples, the techniques described herein relate to a method, further including sodium sulphate.

In some examples, the techniques described herein relate to a method for forming cement, the method including adding sulfate treated water to vaterite, wherein the sulfate is 0.1 to 8% by weight of the vaterite.

In some examples, the techniques described herein relate to a method, further adding calcium carbonate seeds to the cement.

In some examples, the techniques described herein relate to a method, wherein calcium carbonate seed is up to 100% calcite seed.

In some examples, the techniques described herein relate to a method, wherein calcium carbonate seed includes aragonite seed.

In some examples, the techniques described herein relate to a method, wherein the sulfate is provided as calcium sulfate.

In some examples, the techniques described herein relate to a method, wherein the sulfate is provided as gypsum.

In some examples, the techniques described herein relate to a method, further including sodium sulphate.

In some examples, the technique described herein relate to a method for forming a cementitious composition, the method including: determining a desired reaction speed and a desired compressive strength; determining a ratio of weights of vaterite and sulfate according to the desired reaction speed and the desired compressive strength; and, forming the cementitious composition by incorporating the sulfate in the vaterite according to the ratio of weights of vaterite and sulfate.

### BRIEF DESCRIPTION OF THE DRAWINGS

In the accompanying figures:

FIG. 1 is an exemplary flow chart to make a cementitious composition comprising vaterite and sulfate.

FIG. 2 is an illustration of reaction speeds of vaterite with different amounts of incorporated sulfate according to various examples.

FIG. 3 is a flowchart for forming vaterite with added sulfate according to various examples.

FIG. 4 is a flowchart for forming vaterite with infused sulfate according to various examples.

FIG. 5 is a flowchart for forming vaterite with coated sulfate according to various examples.

FIG. 6 is a histogram illustrating the strength of the cementitious composition as a function of weigh ratios according to various examples.

FIG. 7 is a histogram illustrating the strength of mortar cubes as a function of weigh ratios according to various examples.

FIG. 8 is a histogram illustrating the strength and flow of the cementitious composition as a function of different amounts of infused sulfate.

FIG. 9 is an exemplary scanning electron microscope (SEM) image of vaterite which had sulfate incorporated into it during the synthesis process according to various examples.

FIG. 10 is another exemplary SEM image of vaterite which had sulfate incorporated into it during the synthesis process according to various examples.

FIG. 11 is an exemplary scanning electron microscope (SEM) image of vaterite which had sulfate incorporated into it during the synthesis process according to various examples.

FIG. 12 is an example of a system for producing a cementitious composition according to the various examples.

### DETAILED DESCRIPTION

It is to be understood that the present examples are not limited to particular examples described, as such may, of course, vary. It is also to be understood that the terminology used herein is for the purpose of describing particular examples only, and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the invention, representative illustrative methods and materials are described herein.

All publications, patents, and patent applications cited in this specification are incorporated herein by reference to the same extent as if each individual publication, patent, or patent application were specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided may be different from the actual publication dates, which may need to be independently confirmed.

It is noted that, as used herein and in the appended claims, the singular forms “a”, “an”, and “the” include plural references unless the context clearly dictates otherwise. It is further noted that the claims may be drafted to exclude any optional element. As such, this statement is intended to serve as an antecedent basis for use of such exclusive terminology as “solely,” “only” and the like in connection with the recitation of claim elements, or use of a “negative” limitation.

As will be apparent to those of skill in the art upon reading this disclosure, each of the individual examples described and illustrated herein has discrete components and features which may be readily separated from or combined with the features of any of the other several examples without departing from the scope or spirit of the invention. Any recited method can be carried out in the order of events recited or in any other order, which is logically possible.

Various examples described herein relate to a method, composition, and system, for forming a cementitious composition. The cementitious composition contains vaterite and sulfate. In these examples a superior quality cement is produced which is environmentally friendly by reducing the carbon footprint which would be otherwise produced in ordinary cement plants.

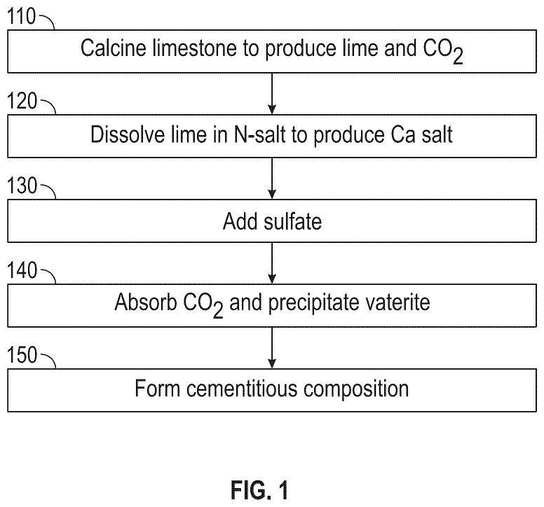

FIG. 1 is an exemplary flow chart to make a cementitious composition comprising vaterite and sulfate. At step 110, limestone is calcined in a kiln. This process produces lime and a gaseous stream which contains carbon dioxide (CO₂).

At step 120, the lime is dissolved in a nitrogen containing salt such as ammonium chloride. At this stage an aqueous solution is produced which contains calcium chloride.

At step 130, sulfate is added to the aqueous solution. The sulfate may be provided as a salt such as calcium sulfate, or sodium sulfate in various amorphous or crystal forms such as gypsum. Any suitable form of sulfate may be used however in various examples.

At step 140, carbon dioxide is absorbed or reabsorbed for a precipitation process. The carbon dioxide may be produced in the kiln which is used for the calcination. It may also be provided from any other process, such as an industrial process, which produces carbon dioxide. As a result of this process, vaterite is produced, which is a reactive polymorph of calcium carbonate forming a cementitious product or a cement with environmental benefits.

As a result of the process of step 140, at step 150, a cementitious product is produced which contains vaterite and sulfate. This cementitious product has superior performance in terms of compressive strength according to the present examples.

In various examples, specific ratios of vaterite and sulfate are used. In some examples, to produce a cementitious composition which is superior in compressive strength, specific ratios of vaterite and sulfate are used.

In some examples of including at least 50% vaterite and 0.1 to 5% sulfate by weight. In some examples, the amount of vaterite is more than 90% of the cementitious composition. In some examples, the amount of vaterite may be more than 97% of the cementitious composition.

The amount of sulfate may be in the range of 0.1 to 10% of the cementitious composition in various examples. In some examples, the amount of the sulfate is between 0.2 to 2% by weight of the cementitious composition.

In various examples, other additives may be used in the cementitious composition. In some examples, the cementitious composition with the reactive vaterite may further include by weight of up to 60% calcium carbonate. The ratio of the added calcium carbonate seed depends on the application of different examples. In general, lesser ratio of reactive components such as vaterite, and greater ratios of non-reactive calcium carbonate such as calcite, may reduce the compressive strength of the cementitious blend, which in turn may bring other benefits that make such compositions useful for lighter duty applications such as boards and pavers.

As discussed above, the cementitious composition may further include calcite seed. In some examples, the calcium carbonate seed added to the cementitious composition with the reactive vaterite may be up to 100% calcite seed.

In some examples, the calcium carbonate added to a cementitious composition with the reactive vaterite may include aragonite seed. Aragonite is a naturally found polymorph of calcium carbonate which may be synthetically manufactured to a desired aspect ratio. Larger aspect ratio particles or crystallites in the aragonite seed may add flexural strength to the cementitious composition in addition to the compressive strength.

In some examples, the sulfate provided in the cementitious composition, is calcium sulfate. Gypsum is soft mineral a white or grey color. Gypsum is made of calcium sulfate and water and is a commercially available form of calcium sulfate that may be added to the cementitious composition.

In some examples, sodium sulfate may be added to the cementitious composition. The addition of sodium sulfate may be along with calcium sulfate. Different sulfate salts may also be used in lieu or in addition to calcium sulfate in different examples.

In some examples, the sulfate may be infused into the vaterite particles. Since the sulfate is added prior to the precipitation of vaterite in a reactor, the sulfate particles, such calcium sulfate are infused into the vaterite particles in these examples.

In some examples, a pre-processing step is devised in which impurities are filtered out of the feedstock of the cementitious composition prior to precipitation of vaterite. These examples make for purer vaterite.

In some a method for forming a cementitious composition includes calcining limestone in kiln to form lime and a gaseous stream including carbon dioxide. This is followed by dissolving the lime into an aqueous solution including a nitrogen containing salt to produce an aqueous solution of calcium salt. Subsequently, this is followed by treating the aqueous solution of calcium salt with sulfate and the gaseous stream including carbon dioxide to form a precipitation material and thereby forming the cementitious composition.

In various examples, the cementitious composition includes vaterite. Optionally, further filtering out impurities prior to treating the aqueous solution may form purer vaterite.

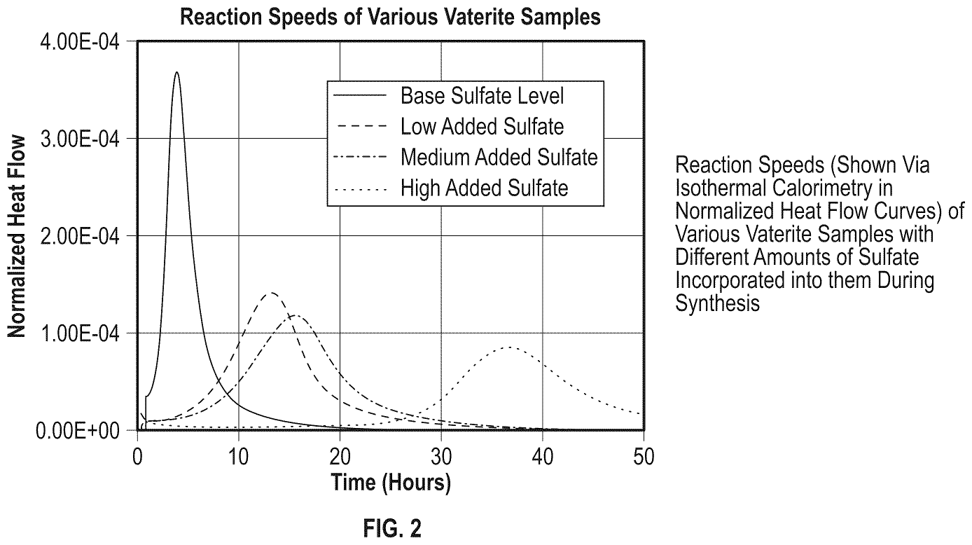

FIG. 2 is an illustration of reaction speeds of vaterite with different amounts of incorporated sulfate according to various examples. The figure shown isothermal calorimetry in normalized heat flow curves of various vaterite samples with different amounts of sulfate incorporated into them during synthesis.

As seen in the figure, the sulfate may act as a retardant which may be another benefit of the present examples. Pure vaterite has a quick reaction time and the addition of sulfate according to the present examples may aid in alleviating the quick setting of the cementitious composition when suitable for the application. According to various examples, the amount of the added sulfate may be fixed according to a desired strength and a desired setting time for an appropriate application.

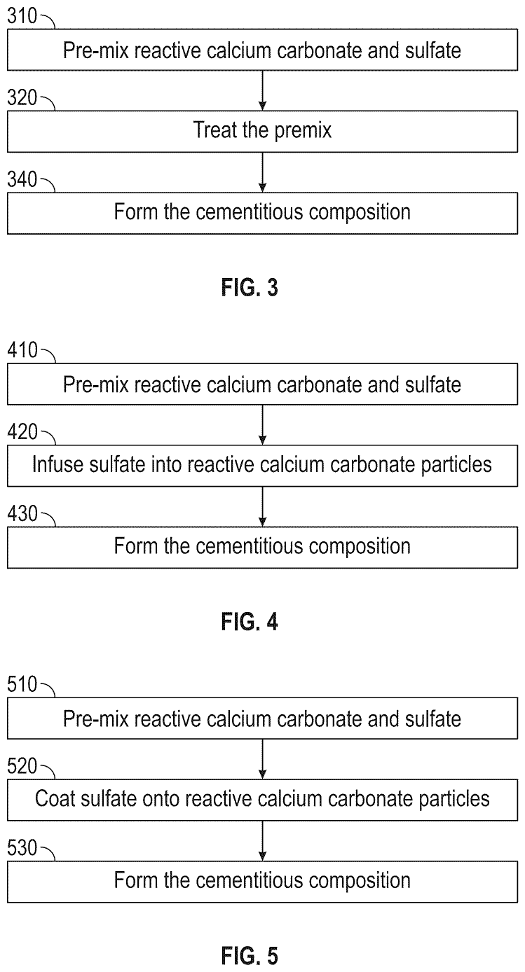

FIG. 3 is a flowchart for forming vaterite with added sulfate according to various examples. At step 310, a premix of vaterite and sulfate is produced. The weight ratio of the vaterite and the sulfate depends on a particular application according to various examples and they depend on various paraments such as compressive strength and setting time. At step 320, the premix may optionally be treated to form the cementitious composition at step 330.

In some examples, the sulfate may be infused into vaterite particles. FIG. 4 is a flowchart for forming vaterite with infused sulfate according to various examples. At step 410, a premix of vaterite and sulfate is produced. The weight ratio of the vaterite and the sulfate depends on a particular application according to various examples and they depend on various paraments such as compressive strength and setting time. At step 420, the sulfate is infused into vaterite particles to form the cementitious composition at step 430.

In some examples, the sulfate may be coated onto vaterite particles. FIG. 5 is a flowchart for forming vaterite with coated sulfate according to various examples. At step 510, a premix of vaterite and sulfate is produced. The weight ratio of the vaterite and the sulfate depends on a particular application according to various examples and they depend on various paraments such as compressive strength and setting time. At step 520, the sulfate is coated onto vaterite particles to form the cementitious composition at step 530.

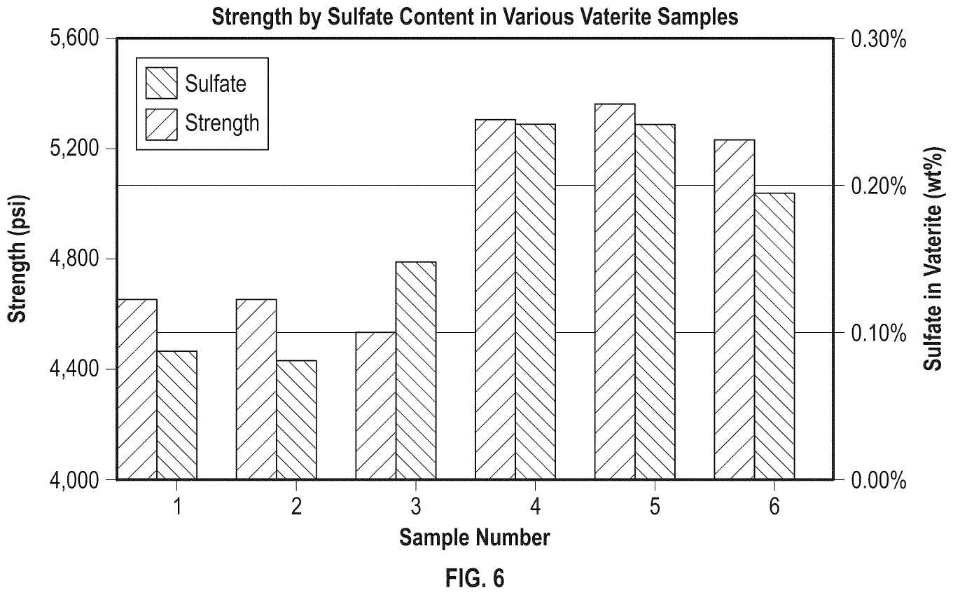

FIG. 6 is a histogram illustrating the strength of the cementitious composition as a function of concentration of sulfate relative to vaterite according to various examples. As seen in the figure, the chart depicts the ultimate strength values of 6 different samples of vaterite with different amounts of sulfate engrained into them during synthesis according to the present examples. The histogram illustrates that higher compressive strength may be reached when the concentration ratio of sulfate relative to vaterite weight ratio is between 0.2 to 0.3 percent.

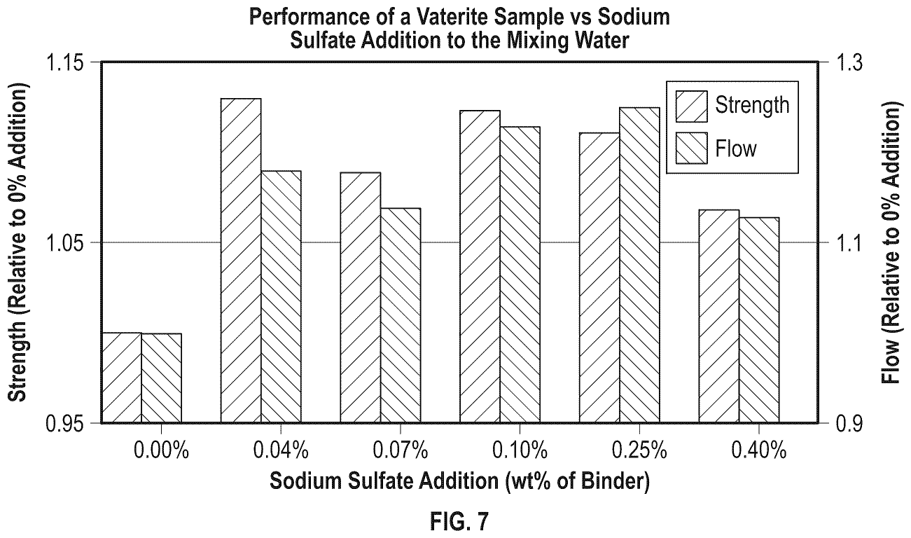

FIG. 7 is a histogram illustrating the strength of mortar cubes as a function of sodium sulfate concentration ratios according to various examples. As seen in the figure, the chart depicts the ultimate strength values of 6 different samples of vaterite with different concentrations of sodium sulfate engrained in the mixing water according to the present examples. Performance parameter (strength or flow) of 1.05 represents a 5% increase in performance relative to the baseline 0% addition of sodium sulfate according to the present examples.

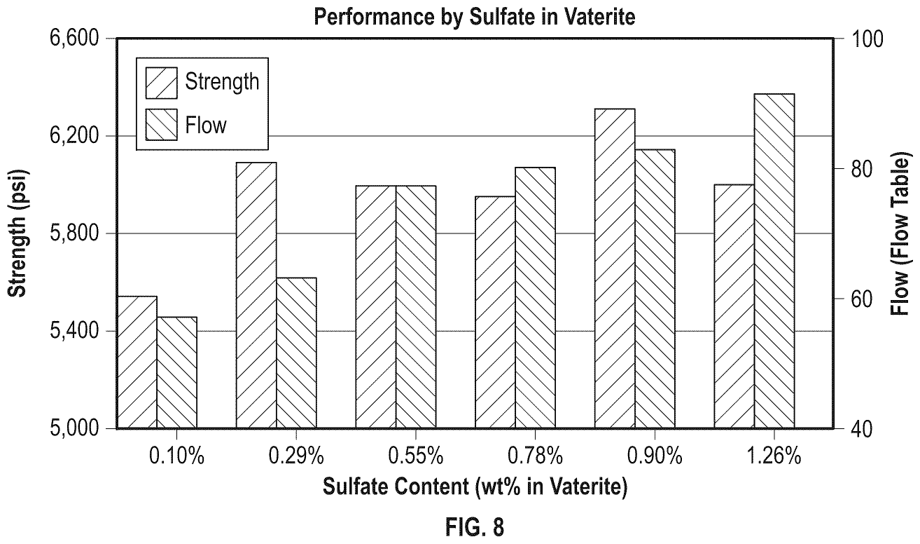

FIG. 8 is a histogram illustrating the strength and flow of the cementitious composition as a function of infused sulfate content. As seen in the figure, the chart depicts the ultimate strength values of 6 different samples of vaterite with different amounts of sulfate infused into them during synthesis according to the present examples. The histogram illustrates that at a 0.90% weight percent of sulfate relative to vaterite according to the present examples, the cementitious composition gains a strength of around 6000 psi while maintaining its flow.

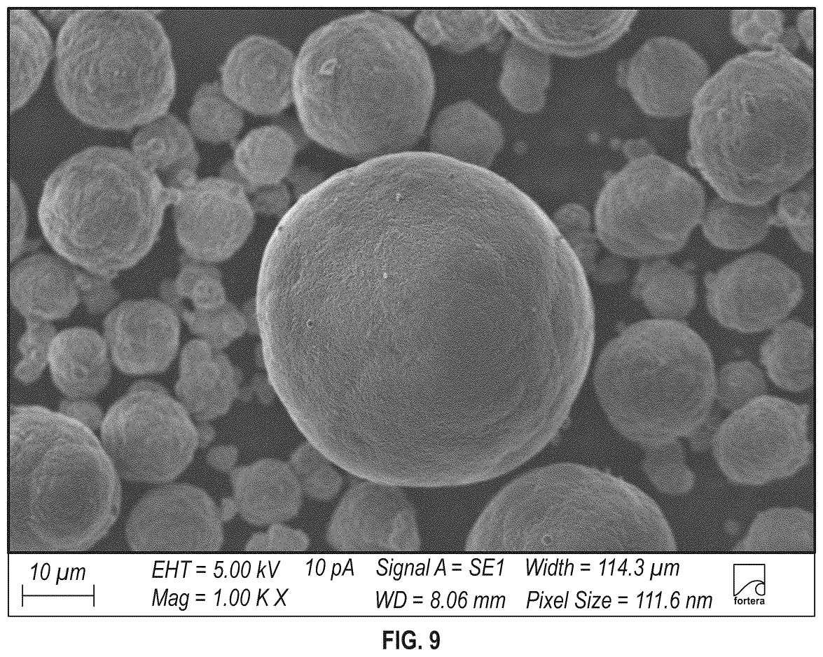

FIG. 9 is an exemplary scanning electron microscope (SEM) image of vaterite which has sulfate incorporated according to various examples. This image focuses on the larger sized particles within the particle distribution of the cementitious composition.

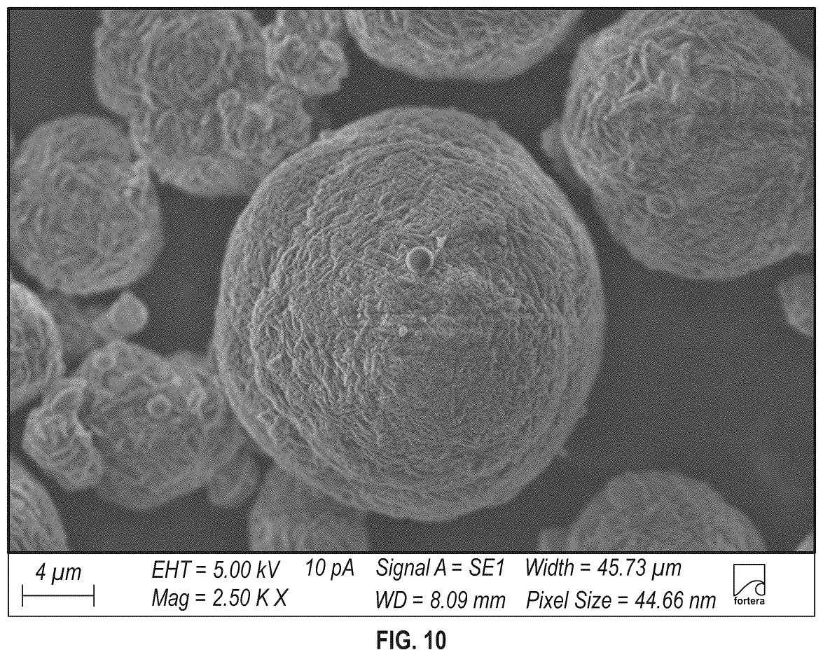

FIG. 10 is another exemplary SEM image of vaterite which had sulfate incorporated into it during the synthesis process according to various examples. This image zooms at a mid sized particles within the particle distribution of the cementitious composition.

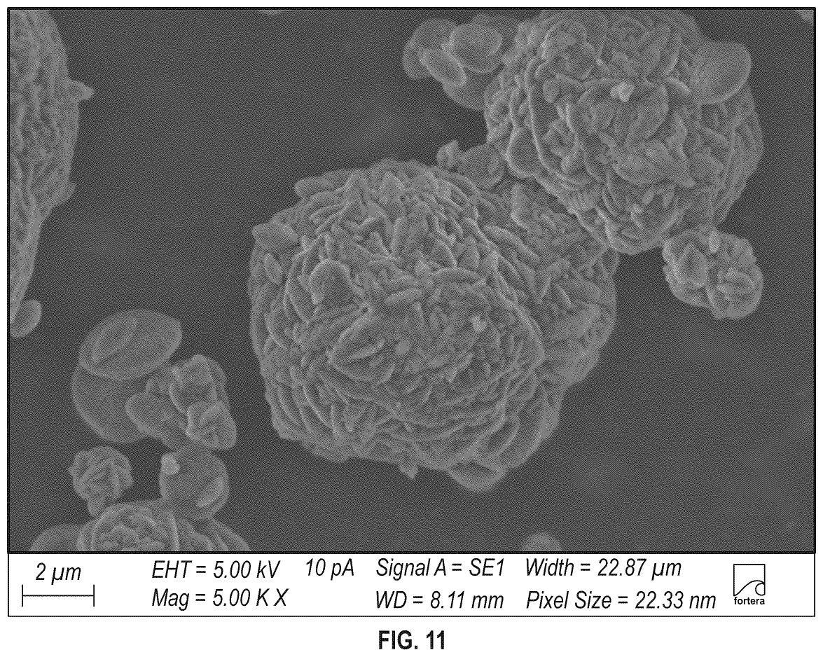

FIG. 11 is an exemplary scanning electron microscope (SEM) image of vaterite which had sulfate incorporated into it during the synthesis process according to various examples. This image depicts some of the smaller particles within the particle distribution of the cementitious composition at even greater magnification.

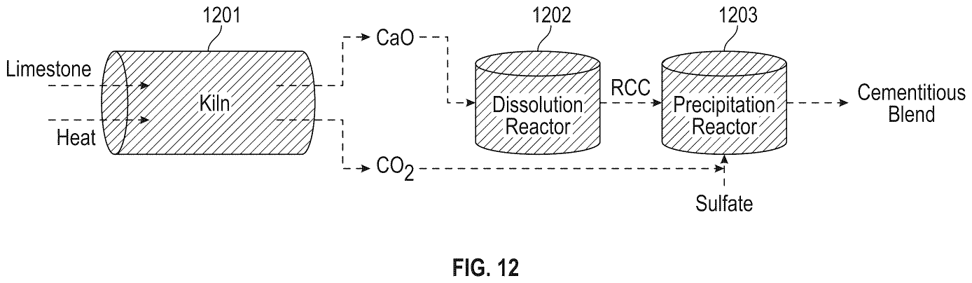

FIG. 12 is an example of a system for producing the cementitious composition according to the various examples. Limestone is calcined in kiln 1201, as a result of which lime and carbon dioxide are produced. The lime is input into dissolution reactor 1202 where it is dissolved in a nitrogen containing salt, thereby producing a calcium salt which is then used for reabsorbing the carbon dioxide and precipitation along with added sulfate in the precipitation reactor 1203. There the vaterite with incorporated sulfate is produced.

Although the foregoing examples have been described in some detail by way of illustration and example for purposes of clarity of understanding, it should be readily apparent to those of ordinary skill in the art in light of the teachings of these examples that certain changes and modifications may be made thereto without departing from the spirit or scope of the appended claims. Accordingly, the preceding merely illustrates the principles of the present examples.

It will be appreciated that those skilled in the art will be able to devise various arrangements, which, although not explicitly described or shown herein, embody the principles of the present examples, and are included within its spirit and scope. Furthermore, all examples and conditional language recited herein are principally intended to aid the reader in understanding the principles of the present examples and the concepts contributed by the inventors to furthering the art, and are to be construed as being without limitation to such specifically recited examples and conditions.

Moreover, all statements herein reciting principles, aspects, and the present examples as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

The scope of the present examples, therefore, is not intended to be limited to the examples shown and described herein. It is intended that the following claims define the scope of the present examples and that processes and structures within the scope of these claims and their equivalents be covered thereby.

1. A cementitious composition comprising at least 50% vaterite and 0.1 to 5% sulfate by weight.

2. The cementitious composition of claim 1, further comprising by weight of up to 50% calcium carbonate seed.

3. The cementitious composition of claim 2, wherein the cementitious composition further comprises calcite seed.

4. The cementitious composition of claim 3, wherein the added calcium carbonate seed is up to 100% calcite seed.

5. The cementitious composition of claim 2, wherein calcium carbonate seed comprises aragonite seed.

6. The cementitious composition of claim 1, wherein the sulfate is provided as calcium sulfate.

7. The cementitious composition of claim 1, wherein the sulfate is provided as gypsum.

8. The cementitious composition of claim 3, further comprising sodium sulfate.

9. The cementitious composition of claim 1, wherein the sulfate is infused in the vaterite.

10. The cementitious composition of claim 1, wherein impurities are filtered out of the cementitious composition.

11. A method for forming a cementitious composition, the method comprising:
calcining limestone in kiln to form lime and a gaseous stream comprising carbon dioxide;
dissolving the lime in an aqueous solution comprising a nitrogen containing salt to produce an aqueous solution comprising calcium salt; and,
treating the aqueous solution comprising calcium salt with sulfate and the gaseous stream comprising carbon dioxide to form a precipitation material and thereby forming the cementitious composition.

12. The method of claim 11, wherein the cementitious composition comprises vaterite.

13. The method of claim 11, further filtering out impurities prior to treating the aqueous solution.

14. The method of claim 11, further adding calcium carbonate seeds to the cementitious composition.

15. The method of claim 14, wherein calcium carbonate seed is up to 100% calcite seed.

16. The method of claim 14, wherein calcium carbonate seed comprises aragonite seed.

17. The method of claim 11, wherein the sulfate is provided as calcium sulfate.

18. The method of claim 11, wherein the sulfate is provided as gypsum.

19. The method of claim 13, further comprising sodium sulphate.

20. The method of claim 12, wherein the sulfate is infused in the vaterite.
